(19) United States
(12) Patent Application Publication
(10) Pub. No.: US 2026/0321512 A1
(43) Pub. Date: Oct. 15, 2026

(54) MULTILAYER CAPACITOR

(71) Applicant: Panasonic Intellectual Property Management Co., Ltd., Osaka (JP)

(72) Inventors: Rei SHIROUCHI, OSAKA FU (JP); Syusaku KOIE, SHIGA KEN (JP); Koji TAKAHASHI, KANAGAWA KEN (JP); Noboru NEGORO, OSAKA FU (JP)

(21) Appl. No.: 19/697,687

(22) Filed: Jun. 4, 2026

Related U.S. Application Data
(63) Continuation of application No. PCT/JP2025/000919, filed on Jan. 15, 2025.

(30) Foreign Application Priority Data
Jan. 17, 2024 (JP) 2024-005653

(51) Int. Cl. H01G 4/30; H01G 4/232; H01G 4/38

(52) U.S. Cl. CPC H01G 4/30; H01G 4/232; H01G 4/38

(57) ABSTRACT

A multilayer capacitor includes first and second capacitor elements each having an anode body and a cathode section, and stacked on top of each other. The anode body of the first capacitor element has first and second portions that protrude from the cathode section in one and the other regions in a first direction, respectively. The anode body of the second capacitor element has third and fourth portions that protrude from the cathode section in one and the other regions in the first direction, respectively. The multilayer capacitor includes first and second anode terminals electrically connected to the first and third portions, respectively, and a cathode terminal electrically connected to the cathode sections of the first and second capacitor elements. The second and fourth portions are electrically connected to each other.

### CROSS REFERENCE TO RELATED APPLICATION

The present application is a continuation application of International Application No. PCT/JP 2025/000919, filed on Jan. 15, 2025, and claims priority with respect to the Japanese Patent Application No. 2024-005653 filed on Jan. 17, 2024. The entire contents of these applications are incorporated herein by reference.

### TECHNICAL FIELD

The present disclosure relates to a multilayer capacitor.

### BACKGROUND

Conventionally, surface-mount multilayer capacitors known as transmission line type noise filters have been known (e.g., JP2009-076651A). The multilayer capacitor of JP2009-076651A includes a box-shaped resin molded case base, a plurality of capacitor elements stacked together, with anodes at both ends and cathodes in the center, and a box-shaped case cover.

### SUMMARY

In recent years, with increasingly higher operating frequency of electronic devices and other reasons, further improvements of the performance of multilayer capacitors have been desired.

One aspect of the present disclosure relates to a multilayer capacitor. The multilayer capacitor includes: a first capacitor element and a second capacitor element each having an anode body, a cathode section, and a dielectric layer interposed between the anode body and the cathode section, the first capacitor element and the second capacitor element being stacked on top of each other, the anode body of the first capacitor element having a first portion that protrudes from the cathode section in one region in a first direction, and a second portion that protrudes from the cathode section in an other region in the first direction, and the anode body of the second capacitor element having a third portion that protrudes from the cathode section in one region in the first direction, and a fourth portion that protrudes from the cathode section in an other region in the first direction; a first anode terminal electrically connected to the first portion of the first capacitor element; a second anode terminal electrically connected to the third portion of the second capacitor element; and a cathode terminal electrically connected to the cathode sections of the first capacitor element and the second capacitor element, wherein the second portion and the fourth portion are electrically connected to each other.

According to the present disclosure, it is possible to provide a multilayer capacitor that reduces noise.

### BRIEF DESCRIPTION OF THE DRAWINGS

FIG. 1A is a schematic sectional view of a multilayer capacitor of Embodiment 1, taken along a line IA-IA in FIG. 2A.

FIG. 1B is a schematic sectional view of the multilayer capacitor of Embodiment 1, taken along a line IB-IB in FIG. 2A.

FIG. 2A is a schematic sectional view of the multilayer capacitor of Embodiment 1, taken along a line IIA-IIA in FIG. 1A.

FIG. 2B is a schematic sectional view of the multilayer capacitor of Embodiment 1, taken along a line IIB-IIB in FIG. 1A.

FIG. 3A is a schematic side sectional view illustrating a capacitor element when the multilayer capacitor is a solid electrolytic capacitor.

FIG. 3B is a schematic side sectional view illustrating a capacitor element when the multilayer capacitor is a ceramic capacitor.

FIG. 4 is a schematic oblique view illustrating first and second capacitor elements and a cathode terminal of Embodiment 1.

FIG. 5 is a schematic oblique view illustrating first and second capacitor elements and a cathode terminal of Embodiment 2.

FIG. 6A is a schematic oblique view of a multilayer capacitor of Embodiment 3, illustrating first and second capacitor elements.

FIG. 6B is a schematic oblique view of the multilayer capacitor of Embodiment 3, illustrating the first and second capacitor elements covered with a package body.

### DETAILED DESCRIPTION

Embodiments of the multilayer capacitor according to the present disclosure will be described below by way of examples, but the present disclosure is not limited to the examples described below. In the following description, specific numerical values and materials are exemplified in some cases, but other numerical values and other materials may be adopted as long as the effects of the present disclosure can be obtained.

The multilayer capacitor according to the present disclosure can be used as a transmission line component having a noise filter function. The multilayer capacitor according to the present disclosure includes a first capacitor element, a second capacitor element, a first anode terminal, a second anode terminal, and a cathode terminal. It suffices that the number of the anode terminals is two or more and the number of the cathode terminals is one or more.

The first capacitor element has an anode body, a cathode section, and a dielectric layer. The anode body is, for example, sheet-like, and has a shape (typically a quadrilateral) with two opposing sides in a first direction, and two opposing sides in a second direction intersecting the first direction. The quadrilateral is preferably a rectangle having short sides and long sides. The anode body of the first capacitor element has a first portion that protrudes from the cathode section in one region in the first direction, and a second portion that protrudes from the cathode section in the other region in the first direction. The first direction is preferably the longitudinal direction of the anode body. The first direction may be orthogonal to the stacking direction, and the second direction may be orthogonal to the first direction and the stacking direction. The one region in the first direction and the other region in the first direction refer to, when the anode body is equally divided into two regions in the first direction of the anode body (preferably, in the longitudinal direction thereof), one and the other of the two regions (the same applies to the anode body of the second capacitor element). When a plurality of first capacitor elements are included, the first portions adjacent to each other in the stacking direction may be electrically connected to each other, and the second portions adjacent to each other in the stacking direction may be electrically connected to each other.

The second capacitor element has a cathode body, a cathode section, and a dielectric layer. The anode body of the second capacitor element has a third portion that protrudes from the cathode section in one region in the first direction, and a fourth portion that protrudes from the cathode section in the other region in the first direction. When a plurality of second capacitor elements are included, the third portions adjacent to each other in the stacking direction may be electrically connected to each other in the stacking direction, and the fourth portions adjacent to each other in the stacking direction may be electrically connected to each other.

The first capacitor element and the second capacitor element are stacked on top of each other. The number of the first capacitor elements and the number of the second capacitor elements are not particularly limited. The first capacitor element and the second capacitor element may be stacked in any order, regardless of the number of each of the capacitor elements. When a plurality of first capacitor elements are included, the first portions are electrically connected to each other, and the second portions are electrically connected to each other. When a plurality of second capacitor elements are included, the third portions are electrically connected to each other, and the fourth portions are electrically connected to each other.

The anode body of each of the first and second capacitor elements may be constituted of a valve metal. Examples of the valve metal constituting the anode body include aluminum, tantalum, niobium, and titanium. The anode body may be a foil of a valve metal, and may be a sintered body of valve metal particles. The anode body of each of the first and second capacitor elements may be constituted of a metal other than the valve metal, and may be a vapor-deposited metal. Examples of such metals include silver, nickel, and palladium.

The dielectric layer of each of the first and second capacitor elements may cover at least part of the anode body. The dielectric layer may be constituted of an oxide (e.g., aluminum oxide) formed on the surface of the anode body by a liquid phase method, such as anodization, or a gas phase method, such as vapor deposition and atomic layer deposition. The dielectric layer may be constituted of sintered particles of a dielectric ceramic composition. The dielectric ceramic composition may be mainly composed of, for example, barium titanate. The dielectric layer is formed so as to be interposed at least between the anode body and the cathode section.

The cathode section of each of the first and second capacitor elements may have a solid electrolyte layer covering at least part of the surface of the dielectric layer, and a cathode layer covering at least part of the surface of the solid electrolyte layer. The cathode sections adjacent to each other in the stacking direction may be electrically connected to each other. The solid electrolyte layer may contain a conductive polymer. The solid electrolyte layer may further contain a dopant, as necessary. The cathode section may be a metal layer constituted of silver, nickel, palladium, etc., and may be a vapor-deposited metal.

As the conductive polymer, any known conductive polymer used in solid electrolytic capacitors, such as π-conjugated conductive polymer, can be used. Examples of the conductive polymer include polymers whose backbones are polypyrrole, polythiophene, polyaniline, polyfuran, polyacetylene, polyphenylene, polyphenylene vinylene, polyacene, and polythiophene vinylene. Preferred among them are a polymer whose backbone is polypyrrole, polythiophene, or polyaniline. The aforementioned polymers also include a homopolymer, a copolymer of two or more kinds of monomers, and derivatives of them (including a substituted derivative having a substituent). For example, polythiophene includes poly(3,4-ethylenedioxythiophene) and the like. The conductive polymer may be used singly or in combination of two or more kinds.

As the dopant, for example, at least one selected from the group consisting of a low-molecular-weight anion and a polyanion is used. The low-molecular-weight anion includes, for example, a sulfate ion, a nitrate ion, a phosphate ion, a borate ion, an organic sulfonate ion, a carboxylate ion, and the like, but are not limited thereto. The dopant that generates an organic sulfonate ion includes, for example, benzenesulfonic acid, p-toluenesulfonic acid, naphthalenesulfonic acid, and the like. The polyanion includes, for example, a polymer-type polysulfonic acid, a polymer-type polycarboxylic acid, and the like. Examples of the polymer-type polysulfonic acid include polyvinylsulfonic acid, polystyrenesulfonic acid, polyallylsulfonic acid, polyacrylsulfonic acid, and polymethacrylsulfonic acid. Examples of the polymer-type polycarboxylic acid include polyacrylic acid and polymethacrylic acid. The polyanion also includes polyestersulfonic acid, phenol sulfonic acid novolac resin, and the like. The polyanion, however, is not limited thereto.

The solid electrolyte layer may further contain, as necessary, a known additive, and a known conductive material other than the conductive polymer. Such a conductive material may be, for example, at least one selected from the group consisting of a conductive inorganic material, such as manganese dioxide, and a TCNQ (7,7,8,8-tetracyanoquinodimethane) complex salt.

The cathode layer may be constituted of a carbon layer formed on the surface of the solid electrolyte layer, and a conductor layer formed on the surface of the carbon layer. The conductor layer may be constituted of a silver paste. As the silver paste, for example, a composition containing silver particles and a resin component (binder resin) can be used. As the resin component, a thermoplastic resin can be used, and a thermosetting resin, such as an imide-series resin and an epoxy resin, is preferably used. For the conductor layer, a metal foil containing aluminum or copper as a base material may be used.

The first anode terminal is electrically connected to the first portion of the first capacitor element. When a plurality of first capacitor elements are included, the first anode terminal may be electrically connected to the first portions of all the first capacitor elements. The first anode terminal may be divided into two or more. The first anode body may be constituted of copper, copper alloy, aluminum, or aluminum alloy, and may be subjected to a plating treatment. The first anode terminal may have a conductor layer (e.g., a silver paste layer) containing conductive particles and a resin material, and at least one plated layer (e.g., Ni/Sn-plated layer). The first anode terminal may be electrically connected to the first portion by crimping, and may be electrically connected to the first portion by welding (e.g., laser welding or resistance welding). The first anode terminal may be a so-called end-face current collecting terminal exposed from the package body.

The second anode terminal is electrically connected to the third portion of the second capacitor element. When a plurality of second capacitor elements are included, the second anode terminal may be electrically connected to the third portions of all the second capacitor elements. The second anode terminal may be divided into two or more. The constituent material of the second anode terminal may be the same as or different from the constituent material of the first anode terminal. The second anode terminal may be electrically connected to the third portion by crimping, and may be electrically connected to the third portion by welding (e.g., laser welding or resistance welding). The second anode terminal may be a so-called end-face current collecting terminal exposed from the package body.

One of the first anode terminal and the second anode terminal may be arranged on one side in the second direction, and the other one of the first anode terminal and the second anode terminal may be arranged on the other side in the second direction. The first anode terminal and the second anode terminal may be spaced apart from each other in the second direction. In the second direction, the length dimension of the first anode terminal may be 50% or less or 45% or less of the length dimension of the first capacitor element. In the second direction, the length dimension of the second anode terminal may be 50% or less or 45% or less of the length dimension of the second capacitor element.

The cathode terminal is electrically connected to the cathode sections of the first capacitor element and the second capacitor element. That is, the cathode terminal is electrically connected to all the cathode sections. The cathode terminal may be electrically connected to the cathode sections via a conductive adhesive. The cathode terminal may be constituted of copper, copper alloy, aluminum, or aluminum alloy, may be subjected to a plating treatment, and may be a vapor-deposited metal. The constituent material of the cathode terminal may be the same as or different from the constituent material of the first anode terminal. The cathode terminal may be divided into two or more. The cathode terminal may be a so-called end-face current collecting terminal exposed from the package body.

The second portion of the first capacitor element and the fourth portion of the second capacitor element are electrically connected to each other. This electrical connection may be achieved by any method. For example, the second portion and the fourth portion may be electrically connected via a metal terminal, and may be electrically connected by cold crimping, laser welding, or the like.

The multilayer capacitor having the above configuration includes a transmission line (in other words, current path) consisting of the first anode terminal, the first portion, a main portion of the first capacitor element (i.e., a part of the first capacitor element, excluding the first portion and the second portion), the second portion, the fourth portion, a main portion of the second capacitor element (i.e., a part of the second capacitor element, excluding the third portion and the fourth portion), the third portion, and the second anode terminal in this order (or in the reverse order). While an electric current containing noise components flows through this transmission line, the noise components flow into the cathode section of each capacitor element and the cathode terminal, and can be thus reduced. The longer the transmission line is, the higher such a noise reduction function is. The transmission line according to the present disclosure, which includes the main portion of the first capacitor element and the main portion of the second capacitor element connected in series, is longer than the transmission line of the conventional multilayer capacitor (i.e., the transmission line including only one main portion of the capacitor element). Therefore, the multilayer capacitor according to the present disclosure can have excellent noise reduction function relative to its size.

The multilayer capacitor according to the present disclosure may include a third anode terminal electrically connected to the second portion of the first capacitor element and the fourth portion of the second capacitor element. In this case, the multilayer capacitor is a four-terminal type multilayer capacitor. Such a four-terminal type multilayer capacitor can be used not only as a multilayer capacitor with a long transmission line as described above, but also, for example, in a configuration in which the third anode terminal is used as an input terminal and the first and second anode terminals are used as output terminals. The third anode terminal may be divided into two or more. The third anode terminal may be constituted of copper, copper alloy, aluminum, or aluminum alloy, and may be subjected to a plating treatment. The third anode terminal may be electrically connected to the second and fourth portions by crimping, and may be electrically connected to the second and fourth portions or by welding (e.g., laser welding or resistance welding). The third anode termina l may be a so-called end-face current collecting terminal exposed from the package body.

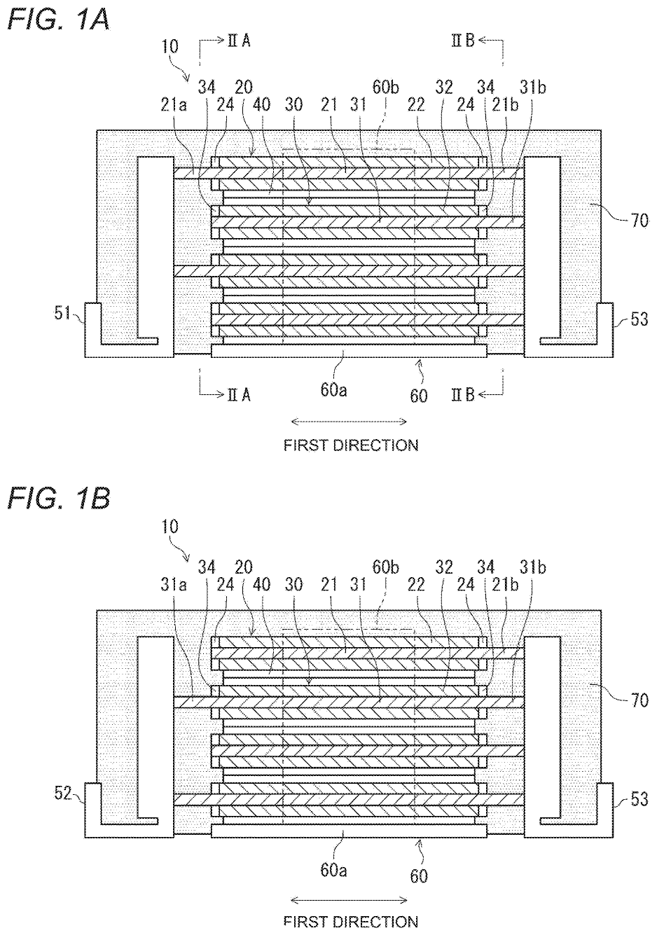

The first portion may protrude from the cathode section of the first capacitor element toward one side in the first direction. The second portion may protrude from the cathode section of the first capacitor element toward the other side in the first direction. The third portion may protrude from the cathode section of the second capacitor element toward one side in the first direction. The fourth portion may protrude from the cathode section of the second capacitor element toward the other side in the first direction. In this case, the transmission line between the first portion and the second portion and the transmission line between the fourth portion and the third portion become longer. Therefore, by making the transmission line from the first to the third portion even longer, the noise reduction performance of the multilayer capacitor can be further improved. Note that at least one of the first and second portions may protrude in the second direction (i.e., the direction orthogonal to the plane of the paper in FIGS. 1A and 1B) from the cathode section of the first capacitor element, and at least one of the third and fourth portions may protrude in the second direction from the cathode section of the second capacitor element.

The first portion may protrude from the cathode section of the first capacitor element in the second direction, and/or, the third portion may protrude from the cathode section of the second capacitor element in the second direction. In this case, the distance between the first portion and the third portion can be easily ensured to be large, leading to a higher arrangement freedom of the first and second anode terminals to be electrically connected to these portions. The second direction may intersect with (preferably, be orthogonal to) the stacking direction and the first direction.

The cathode terminal may include a mounting surface portion located at one end in the stacking direction of the first capacitor element and the second capacitor element, and a side wall portion rising continuously from the mounting surface portion and electrically connected to the side surfaces of the respective cathode sections of the first capacitor element and the second capacitor element. The mounting surface portion and the side wall portion are integrally formed with each other. The mounting surface portion may be electrically connected to the cathode section of the first or second capacitor element closest thereto. The side wall portion may be electrically connected to the side surface of each cathode section via a conductive adhesive. The presence of such a side wall portion reduces the impedance due to the resistance component and the inductance component of the cathode terminal, and the noise reduction function of the multilayer capacitor can be improved. Furthermore, since the side wall portion is integrally formed with the mounting surface portion, a cathode terminal having a mounting surface portion and a side wall portion can be easily formed by, for example, subjecting a predetermined frame material roll to a bending processing.

The first capacitor element and the second capacitor element may have a conductive polymer layer covering at least part of the dielectric layer, or a ceramic layer constituting the dielectric layer. The conductive polymer layer may include the aforementioned kinds of conductive polymers. The ceramic layer may contain, for example, barium titanate and a secondary component. The secondary component may include: at least one selected from dysprosium, holmium, erbium, and yttrium of rare earth elements; at least one selected from manganese and vanadium; at least one selected from silicon and aluminum; barium; and magnesium.

At least a plurality of the second capacitor elements may be included. In this case, it is possible to increase the capacity of the multilayer capacitor, and reduce the equivalent series resistance and the impedance of the multilayer capacitor. A plurality of the first capacitor elements and a plurality of the second capacitor elements may be included. The number of the first capacitor elements and the number of the second capacitor elements may be the same or different.

The first capacitor element and the plurality of the second capacitor elements may be stacked alternately. In this case, the direction of the current flowing through the first capacitor element is opposite the direction of the current flowing through the second capacitor element. Therefore, by stacking the two capacitor elements alternately, the equivalent series inductance of the multilayer capacitor can be reduced.

The cathode terminal may have a mounting surface portion located at one end in the stacking direction of the first capacitor element and the second capacitor elements. The plurality of the second capacitor elements may be stacked all together on the side facing the mounting surface portion. The first capacitor element may be stacked on the side opposite the mounting surface portion. The mounting surface portion may be electrically connected to the cathode section of the second capacitor element closest thereto. Here, the noise reduction function for the current flowing through the capacitor elements is higher as closer to the mounting surface portion. Therefore, in the case of using a multilayer capacitor having the present configuration with the first anode terminal and the second anode terminal each used as an output terminal, an electric circuit for which the noise requirements are relatively strict can be connected to the output terminal corresponding to the second capacitor elements stacked all together on the side facing the mounting surface portion. The cathode terminal may further have a side wall portion rising continuously from the mounting surface portion and electrically connected to the side surfaces of the respective cathode sections of the first capacitor element and the second capacitor element.

As described above, according to the present disclosure, by making the transmission line longer, a multilayer capacitor having excellent noise reduction function can be provided.

In the following, examples of the multilayer capacitor according to the present disclosure will be specifically described with reference to the drawings. The components as described above may be applied to the components of the examples of the multilayer capacitor as described below. The components of the examples of the multilayer capacitor as described below can be changed based on the description above. The matters described below may be applied to the aforementioned embodiments. Of the components of the examples of the multilayer capacitor as described below, those not essential for the multilayer capacitor according to the present disclosure may be omitted. It is to be noted that the figures shown below are schematic ones, and do not accurately reflect the shape and the number of the actual members.

### Embodiment 1

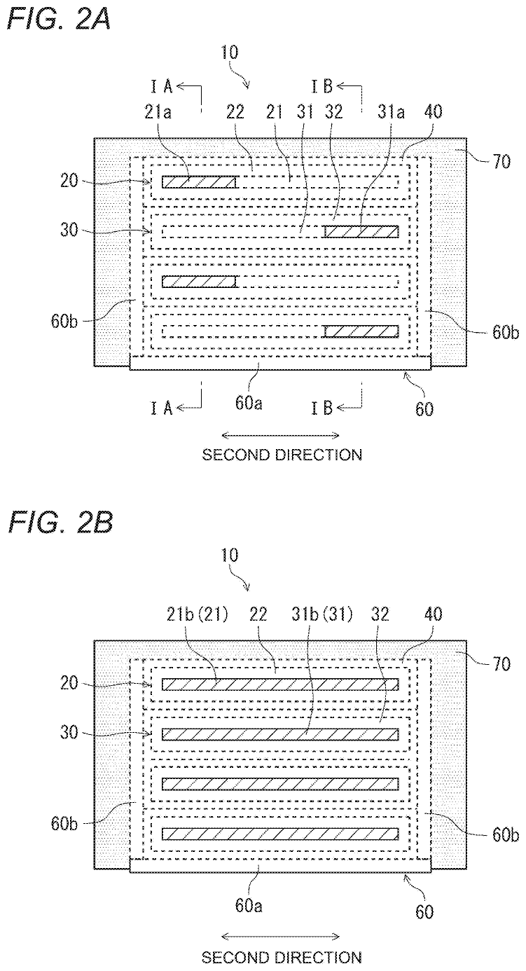

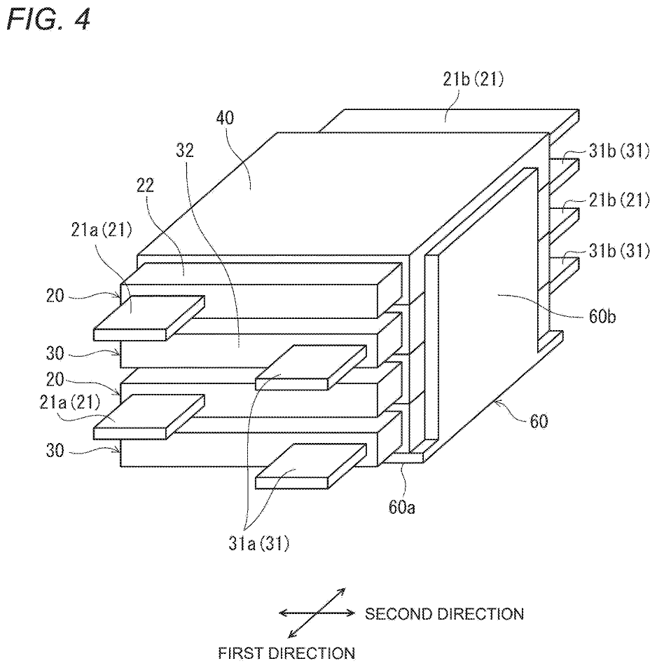

Embodiment 1 of the present disclosure will be described. A multilayer capacitor 10 of the present embodiment includes, as illustrated in FIGS. 1A to 4, at least one (in this example, two) first capacitor element 20, at least one (in this example, two) second capacitor element 30, a first anode terminal 51, a second anode terminal 52, a third anode terminal 53, a cathode terminal 60, and a package body 70. In FIGS. 1A and 1B, a side wall portion 60b described later is shown by a dash-double-dot line.

The first capacitor element 20 has a first anode body 21, a first cathode section 22, and a first dielectric layer 23. The first anode body 21 has a first portion 21a that protrudes from the first cathode section 22 in one region in the longitudinal direction (on the left side in FIGS. 1A and 1B), and a second portion 21b that protrudes from the first cathode section 22 in the other region in the longitudinal direction (on the right side in FIGS. 1A and 1B). The first capacitor element 20 further has a first insulating portion 24 provided between the first anode body 21 and the first cathode section 22, to provide electrical insulation therebetween. The first anode body 21 is an example of the anode body. The first cathode section 22 is an example of the cathode section. The first dielectric layer 23 is an example of the dielectric layer. The longitudinal direction in FIGS. 1A and 1B is an example of the first direction.

A second capacitor element 30 has a second anode body 31, a second cathode section 32, and a second dielectric layer 33. The second anode body 31 has a third portion 31a that protrudes from the second cathode section 32 in one region in the longitudinal direction (on the left side in FIGS. 1A and 1B), and a fourth portion 31b that protrudes from the second cathode section 32 in the other region in the longitudinal direction (on the right side in FIGS. 1A and 1B). The second capacitor element 30 further has a second insulating portion 34 provided between the second anode body 31 and the second cathode section 32, to provide electrical insulation therebetween. The second anode body 31 is an example of the anode body. The second cathode section 32 is an example of the cathode section. The second dielectric layer 33 is an example of the dielectric layer.

The first portion 21a protrudes from the first cathode section 22 toward one side in the longitudinal direction (toward the left side in FIGS. 1A and 1B). The second portion 21b protrudes from the first cathode section 22 toward the other side in the longitudinal direction (toward the right side in FIGS. 1A and 1B). The third portion 31a protrudes from the second cathode section 32 toward one side in the longitudinal direction (toward the left side in FIGS. 1A and 1B). The fourth portion 31b protrudes from the second cathode section 32 toward the other side in the longitudinal direction (toward the right side in FIGS. 1A and 1B). The first to fourth portions 21a, 21b, 31a, and 31b may protrude in the lateral direction (the direction orthogonal to the plane of the paper in FIGS. 1A and 1B) from the first or second cathode section 22, 32. The lateral direction is an example of the second direction.

Two first capacitor elements 20 and two second capacitor elements 30 are stacked on top of each other. In the present embodiment, the two first capacitor elements 20 and the two second capacitor elements 30 are stacked alternately.

The first anode body 21 and the second anode body 31 are each constituted of a foil of a valve metal (in this example, aluminum), but are not limited thereto. The first portions 21a of the two first anode bodies 21 are electrically connected to each other. The third portions 31a of the two second anode bodies 31 are electrically connected to each other. The first portions 21a are not directly connected to the third portions 31a on one side in the longitudinal direction of the multilayer capacitor 10 (on the left side in FIGS. 1A and 1B). In other words, the first portions 21a are spaced apart from the third portions 31a in the lateral direction of the multilayer capacitor 10 (the direction orthogonal to the plane of the paper in FIGS. 1A and 1B).

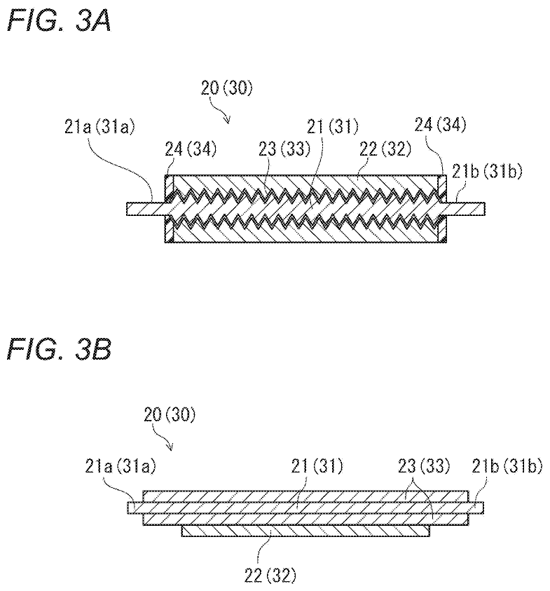

As illustrated in FIG. 3A, the first dielectric layer 23 covers at least part of the surface of the first anode body 21. The first dielectric layer 23 is constituted of an oxide (in this example, aluminum oxide) formed on the surface of the first anode body 21 subjected to a roughening treatment, but is not limited thereto. The second dielectric layer 33 covers at least part of the surface of the second anode body 31. The second dielectric layer 33 is constituted of an oxide (in this example, aluminum oxide) formed on the surface of the second anode body 31 subjected to a roughening treatment, but is not limited thereto.

The first cathode section 22 has a solid electrolyte layer (conductive polymer layer) covering at least part of the first cathode body 23, and a cathode layer covering at least part of the surface of the solid electrolyte layer. The second cathode section 32 has a solid electrolyte layer (conductive polymer layer) covering at least part of the second dielectric layer 33, and a cathode layer covering at least part of the surface of the solid electrolyte layer. The first cathode section 22 and the second cathode section 32 adjacent to each other in the stacking direction (the vertical direction in FIGS. 1A and 1B) are electrically connected to each other via a conductive paste 40. Thus, all the first cathode sections 22 and all the second cathode sections 32 are electrically connected to each other. The solid electrolyte layer contains a conductive polymer and a dopant. The cathode layer is constituted of a carbon layer formed on the surface of the solid electrolyte layer and a conductor layer formed on the surface of the carbon layer. The conductor layer may be constituted of a silver paste. For the conductor layer, a metal foil containing aluminum or copper as a base material may be used.

The multilayer capacitor 10 of the present embodiment is a solid electrolytic capacitor including the first and second capacitor elements 20, 30 of the type illustrated in FIG. 3A. Without limited thereto, the technical concept of the present disclosure is also applicable to a multilayer ceramic capacitor including the first and second capacitor elements 20, 30 of the type illustrated in FIG. 3B. The first and second capacitor elements 20, 30 of FIG. 3B will be briefly described below. Each of the first and second anode bodies 21, 31 is constituted of a metal layer formed within the first or second dielectric layer 23, 33 (ceramic layer) containing barium titanate as a major component. Each of the first and second cathode sections 22, 32 is constituted of a metal layer formed on the surface of the first or second dielectric layer 23, 33. Each of the first and second cathode sections 22, 32 protrudes from the first or second anode body 21, 31 on both the front and rear sides in the direction orthogonal to the plane of the paper in FIG. 3B.

The first anode terminal 51 is electrically connected to the first portion 21a of the first capacitor element 20. The first anode terminal 51 is constituted of copper alloy, but is not limited thereto. The first anode terminal 51 is electrically connected to the first portion 21a by crimping. Instead of or in addition to the crimping, welding may be applied to electrically connect the first anode terminal 51 to the first portion 21a.

The second anode terminal 52 is electrically connected to the third portion 31a of the second capacitor element 30. The second anode terminal 52 is constitute of copper alloy, but is not limited thereto. The second anode terminal 52 is electrically connected to the third portion 31a by crimping. Instead of or in addition to the crimping, welding may be applied to electrically connect the second anode terminal 52 to the third portion 31a.

The third anode terminal 53 is electrically connected to the second portion 21b of the first capacitor element 20, and to the fourth portion 31b of the second capacitor element 30. This provides electrical connection between the second portion 21b and the fourth portion 31b. The third anode terminal 53 is constituted of copper alloy, but is not limited thereto. The third anode terminal 53 is electrically connected to the second portion 21b and the fourth portion 31b by crimping. Instead of or in addition to the crimping, welding may be applied to electrically connect the third anode terminal 53 to the second portion 21b and the fourth portion 31b. The above electrical connection may be realized within the multilayer capacitor 10 (or within the package body 70), without via the third anode terminal 53. As a method to realize this, cold crimping or laser welding may be used, for example.

The cathode terminal 60 is electrically connected to the first cathode section 22 and the second cathode section 32, for example, via a conductive adhesive (not shown). The cathode terminal 60 is constituted of copper alloy, but is not limited thereto.

The cathode terminal 60 has a mounting surface portion 60a located at one end (the lower end in FIGS. 1A and 1B) in the stacking direction of the first and second capacitor elements 20, 30, and a side wall portion 60b rising continuously from the mounting surface portion 60a and electrically connected to the side surfaces of the first cathode sections 22 and the second cathode sections 32. The mounting surface portion 60a is electrically connected to the second cathode section 32 of the second capacitor element 30 which is closest thereto (on the lowest side in FIGS. 1A and 1B). The side wall portion 60b is electrically connected via a conductive adhesive (not shown) to the side surfaces of the respective first cathode sections 22 and the respective second cathode sections 32. The cathode terminal 60 preferably has two or more side wall portions 60b electrically connected to both side surfaces (the side surfaces on the front and rear sides in the direction orthogonal to the plane of the paper in FIGS. 1A and 1B) of the respective first cathode sections 22 and the respective second cathode sections 32.

The package body 70 covers the first and second capacitor elements 20, 30, the first to third anode terminals 51 to 53, and the cathode terminal 60, with the first to third anode terminals 51 to 53 and the cathode terminal 60 each partially exposed therefrom. The package body 70 may be any material having electrically insulating properties, and may be a resin or a ceramic layer, but is not limited thereto. The exposed portions of the first to third anode terminals 51 to 53 and the cathode terminal 60 each function as an external terminal of the multilayer capacitor 10.

### Embodiment 2

Embodiment 2 of the present disclosure will be described. The multilayer capacitor 10 of the present embodiment differs from the above Embodiment 1 in the stacking order of the first and second capacitor elements 20, 30. In the following, the difference from the above Embodiment 1 will be mainly described.

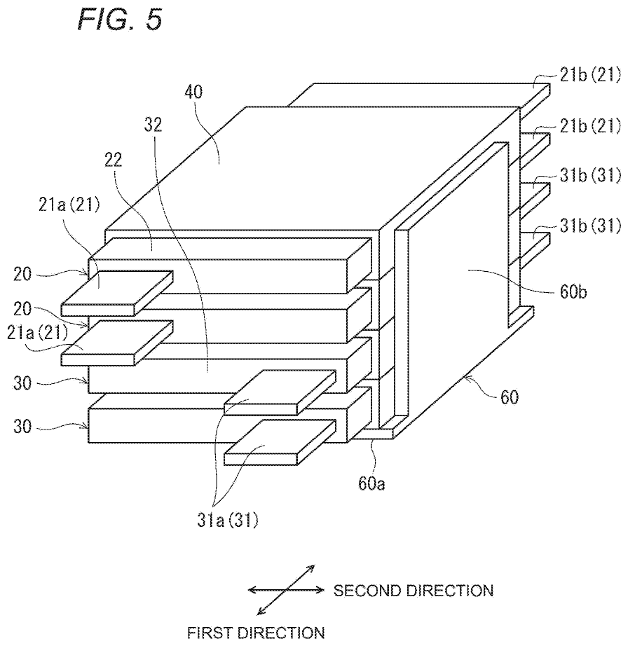

As illustrated in FIG. 5, in the present embodiment, a plurality of (in this example, two) second capacitor elements 30 are stacked all together on the side facing the mounting surface portion 60a of the cathode terminal 60 (on the lower side in FIG. 5), and a plurality of (in this example, two) first capacitor elements 20 are stacked all together on the side opposite the mounting surface portion 60a (on the upper side in FIG. 5).

### Embodiment 3

Embodiment 3 of the present disclosure will be described. The multilayer capacitor 10 of the present embodiment differs in type from the above Embodiment 1. The multilayer capacitor 10 of the present embodiment is a so-called end-face current collecting type multilayer capacitor. In the following, the difference from the above Embodiment 1 will be mainly described.

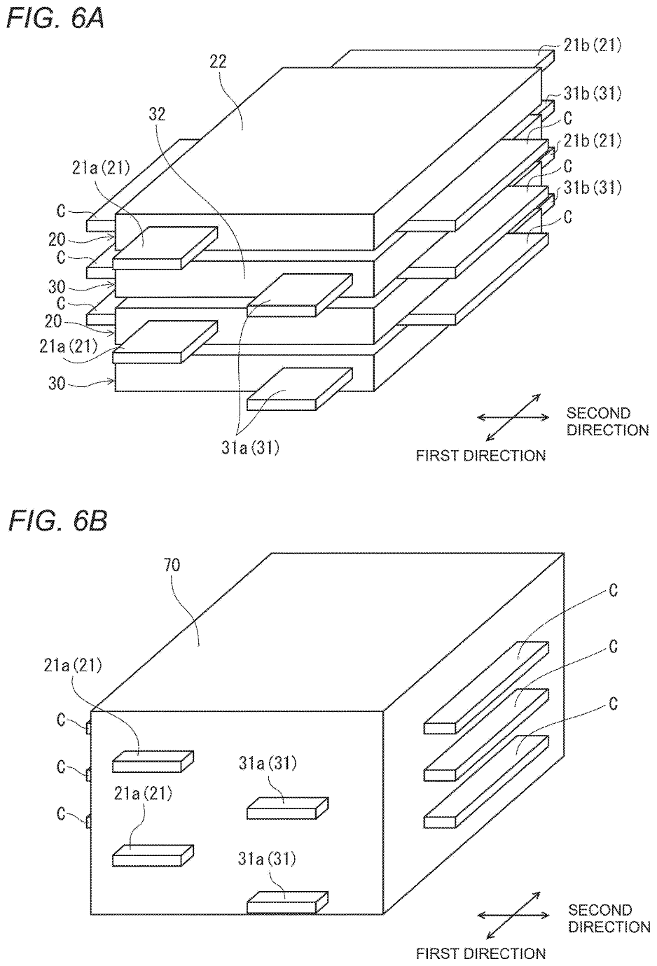

As illustrated in in FIGS. 6A and 6B, the multilayer capacitor 10 of the present embodiment includes a plurality of cathode bodies C electrically connected to the cathode sections 22, 32 of each capacitor element 20, 30 and protruding on both sides in the second direction, between the cathode sections 22, 32. In each of the cathode bodies C, a portion that protrudes toward one side in the second direction and a portion that protrudes toward the other side in the second direction are electrically connected to each other. Each of the cathode bodies C may be constituted of a metal foil or a vapor-deposited metal. By covering the respective components with the package body 70, the state as illustrated in FIG. 6A becomes as illustrated in FIG. 6B. Then, in the state as illustrated in FIG. 6B, by forming first to third anode terminals and a cathode terminal (all not shown) respectively on the portions exposed from the package body 70 of the first to fourth portions 21a, 21b, 31a, 31b and the cathode bodies C by means of, for example, plating, an end-face current collecting type multilayer capacitor 10 is obtained. Note that in FIGS. 6A and 6B, the two protruding portions of each of the cathode bodies C are each denoted by the symbol “C”, which however is for ease of understanding, and each of the cathode bodies C is a single element extending in the second direction.

### Supplementary Notes

The above description of embodiments discloses the following techniques.

### Technique 1

A multilayer capacitor, comprising:
a first capacitor element and a second capacitor element each having an anode body, a cathode section, and a dielectric layer interposed between the anode body and the cathode section, the first capacitor element and the second capacitor element being stacked on top of each other,
   the anode body of the first capacitor element having
      a first portion that protrudes from the cathode section in one region in a first direction, and
      a second portion that protrudes from the cathode section in an other region in the first direction, an
   the anode body of the second capacitor element having
      a third portion that protrudes from the cathode section in one region in the first direction, and
      a fourth portion that protrudes from the cathode section in an other region in the first direction;
a first anode terminal electrically connected to the first portion of the first capacitor element;
a second anode terminal electrically connected to the third portion of the second capacitor element; and
a cathode terminal electrically connected to the cathode sections of the first capacitor element and the second capacitor element, wherein
the second portion and the fourth portion are electrically connected to each other.

### Technique 2

The multilayer capacitor according to technique 1, further comprising a third anode terminal electrically connected to the second portion of the first capacitor element and the fourth portion of the second capacitor element.

### Technique 3

The multilayer capacitor according to technique 1 or 2, wherein
the first portion protrudes from the cathode section of the first capacitor element toward one side in the first direction,
the second portion protrudes from the cathode section of the first capacitor element toward an other side in the first direction,
the third portion protrudes from the cathode section of the second capacitor element toward one side in the first direction, and
the fourth portion protrudes from the cathode section of the second capacitor element toward an other side in the first direction.

### Technique 4

The multilayer capacitor according to technique 1 or 2, wherein
the first portion protrudes from the cathode section of the first capacitor element in a second direction,
and/or,
the third portion protrudes from the cathode section of the second capacitor element in the second direction.

### Technique 5

The multilayer capacitor according to any one of techniques 1 to 4, wherein
the cathode terminal has
   a mounting surface portion located at one end in the stacking direction of the first capacitor element and the second capacitor element, and
   a side wall portion rising continuously from the mounting surface portion and electrically connected to side surfaces of the respective cathode sections of the first capacitor element and the second capacitor element.

### Technique 6

The multilayer capacitor according to any one of techniques 1 to 5, wherein the first capacitor element and the second capacitor element each have a conductive polymer layer covering at least part of the dielectric layer, or a ceramic layer constituting the dielectric layer.
Technique 7

The multilayer capacitor according to any one of techniques 1 to 6, wherein at least a plurality of the second capacitor elements are included.
Technique 8

The multilayer capacitor according to technique 7, wherein the first capacitor element and the plurality of the second capacitor elements are stacked alternately.

### Technique 9

The multilayer capacitor according to technique 7, wherein
the cathode terminal has a mounting surface portion located at one end in the stacking direction of the first capacitor element and the second capacitor elements,
the plurality of the second capacitors are stacked all together on a side facing the mounting surface portion, and
the first capacitor element is stacked on a side opposite the mounting surface portion.

The below-described multilayer capacitors of Example and Comparative Example were evaluated for their characteristics. Specifically, with respect to the multilayer capacitor of Example, a 1-MHz or 100-MHz noise signal was input to the first anode terminal, to evaluate the noise suppression level to the second anode terminal. With respect to the multilayer capacitor of Comparative Example, a 1-MHz or 100-MHz noise signal was input to the anode terminal on one side, to evaluate the noise suppression level to the anode terminal on the other side.

### EXAMPLE

A multilayer capacitor of the type described in the above Embodiment 1 was evaluated. Three first capacitor elements and three second capacitor elements (six in total) were stacked alternately. The noise suppression level was −108 dB for the 1-MHz noise signal and −136 dB for the 100-MHz noise signal.

### Comparative Example

A multilayer capacitor in which six capacitor elements of a different type than Example were stacked together was evaluated. The capacitor elements each include an anode body, a cathode section, and a dielectric interposed therebetween. The anode body has two protruding portions extending from the cathode section on both sides in the longitudinal direction. The multilayer capacitor of Comparative Example includes an anode terminal electrically connected to the protruding portions on one side and an anode terminal electrically connected to the protruding portions on the other side. Thus, in the multilayer capacitor of Comparative Example, the noise signal flows in the same direction through all the six capacitor elements. The noise suppression levels were −84 dB for the 1-MHz noise signal and −87 dB for the 100-MHz noise signal.

As described above, in the multilayer capacitor of Example, the noise suppression level was significantly higher than that in the multilayer capacitor of Comparative Example. The foregoing result shows the superiority of Example.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

The present disclosure is applicable to multilayer capacitors.

### REFERENCE NUMERALS

10: multilayer capacitor
20: first capacitor element
21: first anode body (anode body)
21a: first portion
21b: second portion
22: first cathode section (cathode section)
23: first dielectric layer (dielectric layer)
24: first insulating portion
30: second capacitor element
31: second anode body (anode body)
31a: third portion
31b: fourth portion
32: second cathode section (cathode section)
33: second dielectric layer (dielectric layer)
34: second insulating portion
40: conductive paste
51: first anode terminal
52: second anode terminal
53: third anode terminal
60: cathode terminal
60a: mounting surface portion
60b: side wall portion
70: package body
C: cathode body

What is claimed is:

1. A multilayer capacitor, comprising:
a first capacitor element and a second capacitor element each having an anode body, a cathode section, and a dielectric layer interposed between the anode body and the cathode section, the first capacitor element and the second capacitor element being stacked on top of each other,
the anode body of the first capacitor element having
a first portion that protrudes from the cathode section in one region in a first direction, and
a second portion that protrudes from the cathode section in an other region in the first direction, and
the anode body of the second capacitor element having
a third portion that protrudes from the cathode section in one region in the first direction, and
a fourth portion that protrudes from the cathode section in an other region in the first direction;
a first anode terminal electrically connected to the first portion of the first capacitor element;
a second anode terminal electrically connected to the third portion of the second capacitor element; and
a cathode terminal electrically connected to the cathode sections of the first capacitor element and the second capacitor element, wherein
the second portion and the fourth portion are electrically connected to each other.

2. The multilayer capacitor according to claim 1, further comprising a third anode terminal electrically connected to the second portion of the first capacitor element and the fourth portion of the second capacitor element.

3. The multilayer capacitor according to claim 1, wherein
the first portion protrudes from the cathode section of the first capacitor element toward one side in the first direction,
the second portion protrudes from the cathode section of the first capacitor element toward an other side in the first direction,
the third portion protrudes from the cathode section of the second capacitor element toward one side in the first direction, and
the fourth portion protrudes from the cathode section of the second capacitor element toward an other side in the first direction.

4. The multilayer capacitor according to claim 1, wherein
the first portion protrudes from the cathode section of the first capacitor element in a second direction,
and/or,
the third portion protrudes from the cathode section of the second capacitor element in the second direction.

5. The multilayer capacitor according to claim 1, wherein
the cathode terminal has
a mounting surface portion located at one end in the stacking direction of the first capacitor element and the second capacitor element, and
a side wall portion rising continuously from the mounting surface portion and electrically connected to side surfaces of the respective cathode sections of the first capacitor element and the second capacitor element.

6. The multilayer capacitor according to claim 1, wherein the first capacitor element and the second capacitor element each have a conductive polymer layer covering at least part of the dielectric layer, or a ceramic layer constituting the dielectric layer.

7. The multilayer capacitor according to claim 1, wherein at least a plurality of the second capacitor elements are included.

8. The multilayer capacitor according to claim 7, wherein the first capacitor element and the plurality of the second capacitor elements are stacked alternately.

9. The multilayer capacitor according to claim 7, wherein
the cathode terminal has a mounting surface portion located at one end in the stacking direction of the first capacitor element and the second capacitor elements,
the plurality of the second capacitors are stacked all together on a side facing the mounting surface portion, and
the first capacitor element is stacked on a side opposite the mounting surface portion.
